(19) United States
(12) Patent Application Publication
(10) Pub. No.: US 2025/0320947 A1
(43) Pub. Date: Oct. 16, 2025

(54) PIPE TRANSPORT DEVICE AND PIPING METHOD

(71) Applicant: Kubota Corporation, Osaka-shi (JP)

(72) Inventors: Yuito KOMARU, Amagasaki-shi (JP); Keita ODA, Amagasaki-shi (JP)

(21) Appl. No.: 19/250,789

(22) Filed: Jun. 26, 2025

Related U.S. Application Data
(63) Continuation-in-part of application No. PCT/JP2023/046135, filed on Dec. 22, 2023.

(30) Foreign Application Priority Data
Dec. 27, 2022 (JP) 2022-210885

(51) Int. Cl. F16L 55/165

(52) U.S. Cl. CPC F16L 55/1652

(57) ABSTRACT

A pipe transport device that transports a pipe to be installed in an existing pipeline includes a pipe support that is a rod-shaped structure and penetrates the flexible pipe to support the pipe, and pipe transporters detachably supporting the pipe support and configured to transfer the supported pipe support. The pipe transporters are configured to transfer, in the existing pipeline, the pipe supported by the pipe support along an axial direction of the pipeline, in a state where the pipe transporters support the pipe support.

### CROSS REFERENCE TO RELATED APPLICATIONS

This application claims the benefit of priority to Japanese Patent Application No. 2022-210885 filed on Dec. 27, 2022 and is a Continuation in part Application of PCT Application No. PCT/JP2023/046135 filed on Dec. 22, 2023. The entire contents of each application are hereby incorporated herein by reference.

### BACKGROUND OF THE INVENTION

### 1. Field of the Invention

The present invention relates to, for example, pipe transport devices that each transport a pipe to be installed in an existing pipeline, and piping methods to installing pipes in existing pipelines.

### 2. Description of the Related Art

As a trenchless renewal method for aging existing pipelines, a pipe-in-pipe method (hereinafter referred to as a “PIP method”), for example, is known. The PIP method is a method in which shafts are constructed at each of one end and the other end of an existing pipeline, and new pipes are transported from the constructed shafts into the existing pipeline and joined together within the existing pipeline.

The PIP method enables efficient and economical piping construction in that the PIP method does not require a space for pipe-joining work within the existing pipeline. Various proposals have been made concerning such a PIP method.

For example, Japanese Patent Application Publication No. 2019-011775 discloses a technique of renewing a pipeline using a bellows pipe having elastic flexibility in a PIP method. More specifically, Japanese Patent Application Publication No. 2019-011775 discloses the use of a connecting pipe in which a plurality of flexible bellows pipes are sequentially connected in the PIP method. The connecting pipe is carried into the worksite in a state where the connecting pipe has been wound up on a winding device located at the start end beforehand. A wire is attached to one end of the connecting pipe. The wire is coupled to a winding device at a terminal end through an existing pipeline located between shafts at two locations. By winding the wire with the winding device located at the terminal end, the connecting pipe is placed in the existing pipeline.

### SUMMARY OF THE INVENTION

In the PIP method of Japanese Patent Application Publication No. 2019-011775, the connecting pipe constituted by the flexible bellows pipes is pulled by the wire. Therefore, there is a possibility that the connecting pipe may come into contact with the inner wall of the existing pipeline or the like while being fed from the winding device located at the start end until the connecting pipe is disposed inside the existing pipeline. In this manner, when the connecting pipe comes into contact with the inner wall of the existing pipeline or the like, an unexpected force is applied to the connecting pipe, and the connecting pipe might be deformed.

Furthermore, it is difficult to convey the connecting pipe by pulling the connecting pipe with the wire while preventing contact with the inner wall or the like within the existing pipeline. A technique is required to transfer flexible pipes to the piping place in a stable posture. Moreover, since efficiency is required in the construction of the pipeline, it is desirable to transfer the pipes efficiently.

Example embodiments of the present invention provide pipe transport devices each capable of efficiently transferring a flexible pipe in a stable posture within a pipeline.

A pipe transport device according to an example embodiment of the present invention to transport a pipe to be installed in an existing pipeline includes a pipe support that is a rod-shaped structure and penetrates the pipe to support the pipe, the pipe having flexibility, and a pipe transporter detachably supporting the pipe support and configured to transfer the supported pipe support. The pipe transporter is configured to transfer the pipe supported by the pipe support along an axial direction of the pipeline in the existing pipeline, in a state where the pipe transporter supports the pipe support. (first configuration)

In the configuration described above, the pipe transporter detachably supports the pipe support. Thus, in the state where the pipe support is detached from the pipe transporter, the pipe support can be inserted into the pipe. In addition, in the state where the pipe support penetrates and supports the pipe, the pipe transporter can support the pipe support. In this manner, the flexible pipe is supported by the pipe support in the state where the pipe support penetrates the pipe. Accordingly, the posture of the pipe during transfer can be stabilized. This can prevent contact of the pipe with the existing pipeline during transfer.

Further, since the pipe support penetrates the pipe, after the pipe is transported to a predetermined position in the existing pipeline, the pipe support is detached from the pipe transporter, and in this state, the pipe support can be easily pulled out from the pipe.

As described above, in this configuration, since the flexible pipe is supported by the pipe support in the state where the pipe support penetrates the pipe, the posture of the pipe during transfer can be stabilized. In addition, in the above configuration, the pipe support can be easily pulled out from the pipe in the state where the pipe support is detached from the pipe transporter. Thus, high workability is obtained in pulling out the pipe support from the pipe.

In the manner described above, the flexible pipe can be efficiently transferred in a stable posture in the pipeline.

In the first configuration, the pipe support includes a rod-shaped portion extending in one direction, and a projection portion that projects in a direction intersecting with the one direction with respect to the rod-shaped portion, and supports a coupling of the pipe. The pipe includes a plurality of displacement portions and the coupling is configured to couple the displacement portions to each other. (second configuration)

In this configuration, the projection portion of the pipe support penetrating the pipe supports the coupling of the pipe. Accordingly, the pipe support can support the coupling that is not likely to be displaced by the projection portion while avoiding the displacement portion that is likely to be displaced in the pipe. As a result, deformation of the pipe can be reduced or prevented during transfer by the pipe support.

In the second configuration, a position of the projection portion in the one direction is adjustable relative to the rod-shaped portion. (third configuration)

In this configuration, the position of the projection portion relative to the rod-shaped portion in the pipe support can be adjusted in accordance with the position of the coupling of the pipe. As a result, versatility of the pipe transport device can be enhanced.

A piping method according to an example embodiment of the present invention is a method for installing a pipe in an existing pipeline.

The piping method includes a pipe support insertion step of inserting a pipe support into the pipe having flexibility, a pipe support supporting step of supporting the pipe support with a pipe transporter, and a pipe transfer step of transferring by the pipe transporter, in the existing pipeline, the pipe being supported by the pipe support along an axial direction of the pipeline. (fourth configuration)

In this configuration, the pipe support can be transferred by the pipe transporter in the state where the pipe support penetrates and supports the pipe. Accordingly, the posture of the pipe during transfer can be stabilized. This can prevent contact of the pipe with the existing pipeline during transfer.

Further, since the pipe support penetrates the pipe, after the pipe is transported to a predetermined position in the existing pipeline, the pipe support is detached from the pipe transporter, and in this state, the pipe support can be easily pulled out from the pipe.

In the manner described above, in the configuration described above, the flexible pipe is supported by the pipe support in the state of being penetrated by the pipe support. Accordingly, the posture of the pipe during transfer can be stabilized. In addition, in the above configuration, the pipe support can be easily pulled out from the pipe in the state where the pipe support is detached from the pipe transporter. As a result, high workability is obtained.

In the manner described above, the flexible pipe can be efficiently transferred in a stable posture in the pipeline.

In the fourth configuration, the piping method further includes, after the pipe transfer step, in a state where the pipe support is detached from the pipe transporter, a pipe support pull-out step of pulling out the pipe support from the pipe. A pipeline includes a first straight pipe portion including an opening at one end, a bent pipe portion including one end connected to another end of the first straight pipe portion, and a second straight pipe portion including one end connected to another end of the bent pipe portion. The piping method further includes a moving step of pulling the pipe from the second straight pipe portion of the pipeline to move the pipe to the another end of the bent pipe portion while bending the pipe along a curve of the bent pipe portion. (fifth configuration)

In this configuration, in the pipeline including the bent pipe portion, the pipe is pulled from the second straight pipe portion of the pipeline so that the pipe is moved to the another end of the bent pipe portion while bending along the curve of the bent pipe portion. Accordingly, the flexible pipe can be bent and piped in the bent pipe portion. Accordingly, the pipe can be provided not only in the straight pipe portion, but also in the bent pipe portion in a bent state. Thus, the piping method enabling piping the pipe in various existing pipelines can be obtained. In addition, a pipeline including the bent pipe portion, which has been difficult to renew unless a shaft is constructed, can be easily renewed. That is, in the configuration described above, construction can be performed even on the bent pipe portion where a shaft cannot be constructed due to conditions such as traffic conditions.

In the fifth configuration, the moving step includes a support ring setting step of setting a support ring in the second straight pipe portion, a winding device disposing step of disposing a winding device in the support ring, a coupling step of coupling the pipe and the winding device to each other by a wire, and a pulling step of pulling the pipe toward the support ring by winding the wire by the winding device. (sixth configuration)

In this configuration, the use of the support ring can obtain a reaction force in the pipeline. This eliminates the necessity for supplying a force of pulling the pipe from the outside of the shaft. Accordingly, in the moving step, the pipe can be more efficiently moved to the bent pipe portion.

In the fifth or sixth configuration, in the pipe support pull-out step, a pipe lifting jig is set in the first straight pipe portion and lifts the pipe support relative to the pipe transporter so that the pipe support is separated from the pipe transporter and the pipe support is pulled out from the pipe. (seventh configuration)

In this configuration, while the pipe support is lifted relative to the pipe transporter by using the pipe lifting jig, the pull-out work of the pipe support from the pipe can be performed. After the pipe support is pulled out from the pipe, the pipe can be lowered by the pipe lifting jig. In this manner, the pipe lifting jig can be used to efficiently perform the pull-out work of the pipe support and the disposing work of the pipe. Accordingly, the pull-out work of the pipe support can be more efficiently performed.

In the seventh configuration, in the pipe support pull-out step, in the state where the pipe support is separated from the pipe transporter, the pipe transporter is retracted relative to the pipe. (eighth configuration)

In this configuration, the retracted pipe transporter can be collected. Thus, the collected pipe transporter can be reused.

In the eighth configuration, the piping method further includes a caster attachment step of attaching, to an outer surface of the pipe, a caster configured to move the pipe in the existing pipeline, before the moving step. (ninth configuration)

In this configuration, by attaching the caster to the outer surface of the pipe, the pipe can be easily moved in the existing pipeline. Thus, in the moving step after the pipe transporter is retracted, a force of pushing the pipe into the bent pipe portion can be reduced.

A pipe transport device according to an example embodiment of the present invention includes a pipe support that is a rod-shaped structure and penetrates a pipe to support the pipe, the pipe having flexibility, and a pipe transporter detachably supporting the pipe support and configured to transfer the supported pipe support. The pipe transporter is configured to transfer, in the existing pipeline, the pipe supported by the pipe support along an axial direction of the pipeline, in a state where the pipe support supports the pipe transporter.

Accordingly, the flexible pipe is supported by the pipe support while being penetrated by the pipe support. At a transfer position of the pipe, the pipe support can be easily pulled out from the pipe. Thus, the flexible pipe can be efficiently transported in a stable posture within the pipeline.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view illustrating a schematic configuration of a pipe transport device according to a first example embodiment of the present invention.

FIG. 2 is an enlarged side view illustrating a schematic configuration of a pipe transporter of the pipe transport device.

FIG. 3 is an enlarged front view illustrating a schematic configuration of the pipe transporter of the pipe transport device.

FIG. 4 is a flowchart showing process steps of a piping method according to the first example embodiment of the present invention.

FIG. 5 is a view for describing an operation of attaching a pipe suspended by a wire rope to the pipe transporters.

FIG. 6 is a view for describing a state where a pipe support is supported by the pipe transporters.

FIG. 7 is a side view illustrating a schematic configuration of a pipe transport device according to a second example embodiment of the present invention.

FIG. 8 is a side view illustrating a schematic configuration of a pipe according to the second example embodiment of the present invention.

FIG. 9A is a view schematically illustrating a pipe transfer step of a piping method according to the second example embodiment of the present invention.

FIG. 9B is a view schematically illustrating a support ring setting step, a winding device disposing step, and a coupling step of the piping method according to the second example embodiment of the present invention.

FIG. 9C is a view schematically illustrating a pulling step of the piping method according to the second example embodiment of the present invention.

FIG. 9D is a view schematically illustrating a piping step for a coupling collar and a straight pipe of the piping method according to the second example embodiment of the present invention.

FIG. 10 is a flowchart showing process steps of the piping method according to the second example embodiment of the present invention.

FIG. 11 is a view for describing an operation of attaching a pipe suspended by wire ropes to pipe transporters.

FIG. 12 is a view illustrating the pipe in FIG. 11 in a vertical cross section.

FIG. 13 is a view for describing a state where the pipe support is supported by the pipe transporters.

FIG. 14A is a view illustrating a portion of the pipe transfer step.

FIG. 14B is an enlarged cross-sectional view taken along line XIVB-XIVB in FIG. 14A.

FIG. 15A is a view illustrating another portion of the pipe transfer step.

FIG. 15B is an enlarged cross-sectional view taken along line XVB-XVB in FIG. 15A.

FIG. 16A is a view for describing a setting operation of pipe lifting jigs in a pipe support pull-out step.

FIG. 16B is an enlarged cross-sectional view taken along line XVIB-XVIB in FIG. 16A.

FIG. 17A is a view for describing a pipe lifting operation in the pipe support pull-out step.

FIG. 17B is an enlarged cross-sectional view taken along line XVIIB-XVIIB in FIG. 17A.

FIG. 18A is a view for describing a pull-out operation of transporters in the pipe support pull-out step.

FIG. 18B is an enlarged cross-sectional view taken along line XVIIIB-XVIIIB in FIG. 18A.

FIG. 19A is a view for describing a mount operation of a pipe in the pipe support pull-out step.

FIG. 19B is an enlarged cross-sectional view taken along line XIXB-XIXB in FIG. 19A.

FIG. 20A is a view for describing a pull-out operation in the pipe support pull-out step.

FIG. 20B is an enlarged cross-sectional view taken along line XXB-XXB in FIG. 20A.

FIG. 21A is a piping diagram for describing a moving step.

FIG. 21B is an enlarged cross-sectional view taken along line XXIB-XXIB in FIG. 21A.

FIG. 22 is a piping diagram illustrating a state after pulling of the pipe.

FIG. 23A is a piping diagram illustrating a state at setting of lifting jigs.

FIG. 23B is an enlarged cross-sectional view taken along line XXIIIB-XXIIIB in FIG. 23A.

FIG. 23C is a view corresponding to FIG. 23B and illustrating a state at setting of a crosstie.

### DETAILED DESCRIPTION OF THE EXAMPLE EMBODIMENT

Example embodiments of the present invention will be described hereinafter with reference to the drawings. In the drawings, the same or corresponding elements are denoted by the same reference characters, and description thereof will not be repeated. The dimensions of components in the drawings do not strictly represent actual dimensions of the components and dimensional proportions of the components.

Hereinafter, arrow UP in the drawings represents an upward direction of a pipe transport device 1. Arrow DW in the drawings represents a downward direction of the pipe transport device 1. Arrow FR in the drawings represents a forward direction of the pipe transport device 1. Arrow RR in the drawings represents a rearward direction of the pipe transport device 1.

Hereinafter, arrow PUP in the drawings represents an upward direction of an existing pipeline PL. Arrow PDW in the drawings represents a downward direction of the existing pipeline PL.

Hereinafter, arrow DUP in the drawings represents an upward direction of pipe transporters 12A and 12B. Arrow DDW in the drawings represents a downward direction of the pipe transporters 12A and 12B. Arrow DFR in the drawings represents a forward direction of the pipe transporters 12A and 12B. Arrow DRR in the drawings represents a rearward direction of the pipe transporters 12A and 12B. Arrow DRG in the drawings represents a rightward direction of the pipe transporters 12A and 12B. Arrow DLF in the drawings represents a leftward direction of the pipe transporters 12A and 12B.

In the following description, the term “same” includes not only a case where values or components are strictly the identical but also a case where values or components are in a range that can be regarded as substantially the same. Therefore, the same degree is acceptable as long as the effect of the invention is achieved.

In the following description, expressions such as “fixed,” “connected,” and “attached” include not only a case where structures are directly fixed or the like but also a case where the structures are fixed or the like through other structures. That is, in the following description, the expression such as “fixed or the like” includes meanings of direct and indirect fixing or the like between structures.

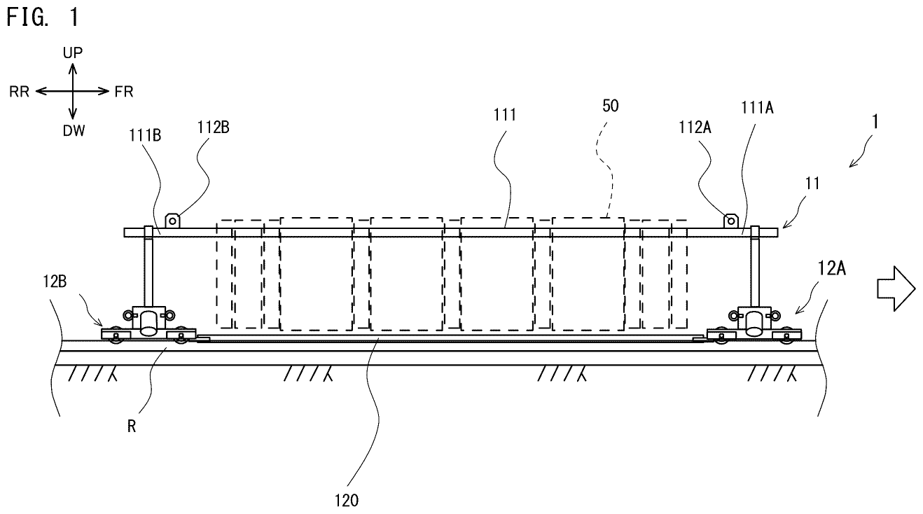

FIG. 1 is a side view illustrating a schematic configuration of a pipe transport device 1 according to a first example embodiment of the present invention. As illustrated in FIG. 1, the pipe transport device 1 transports a pipe 50 to be installed in an existing pipeline. The pipe transport device 1 includes a pipe support 11 and pipe transporters 12A and 12B.

The pipe support 11 is a rod-shaped structure extending in one direction that is a front-rear direction of the pipe transport device 1, and penetrates the pipe 50 to support the pipe 50, the pipe 50 having flexibility. The pipe 50 is, for example, a SUS bellows pipe (bellows-type extensible flexible pipe). The pipe support 11 includes a rod-shaped portion 111 and anchors 112A and 112B.

The rod-shaped portion 111 is a rod-shaped structure extending in the one direction. The length of the rod-shaped portion 111 in the one direction is longer than that of the pipe 50.

The anchors 112A and 112B are respectively located at a first end 111A and a second end 111B, which are both ends of the rod-shaped portion 111 in the one direction.

As illustrated in FIG. 1, the pipe transporters 12A and 12B are a pair of dollies detachably supporting the pipe support 11 and configured to transfer the supported pipe support 11. The pipe transporter 12A is located at the first end 111A of the rod-shaped portion 111 of the pipe support 11. The pipe transporter 12B is located at the second end 111B of the rod-shaped portion 111 of the pipe support 11. That is, the pipe transporter 12A is located at an end of the pipe transport device 1 in the forward direction FR. The pipe transporter 12B is located at an end of the pipe transport device 1 in the rearward direction RR. The pipe transporters 12A and 12B are coupled to each other by a coupler 120. The pipe transporters 12A and 12B have the same configuration except the coupling positions to the coupler 120.

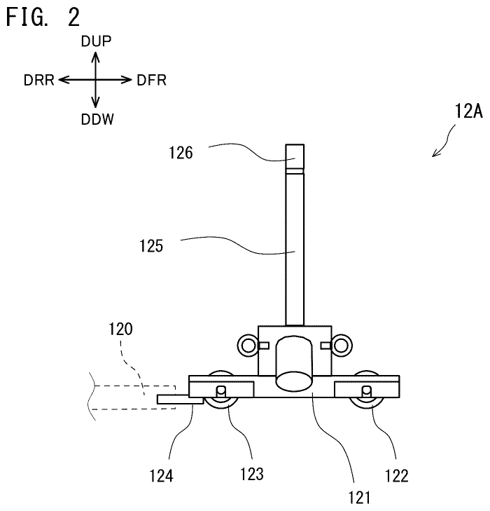

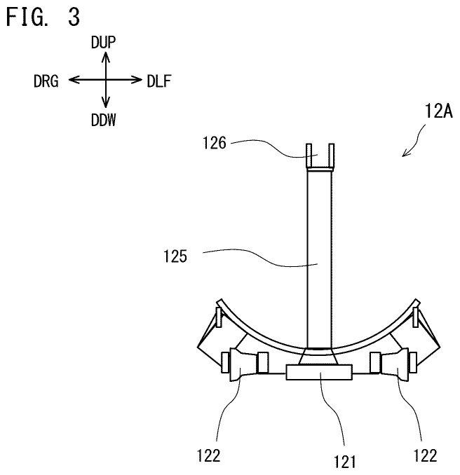

Further, with reference to FIGS. 2 and 3, a specific configuration of the pipe transporter 12A located at the forward end of the pipe transport device 1 will be exemplarily described below. FIG. 2 is an enlarged side view illustrating a schematic configuration of the pipe transporter 12A of the pipe transport device 1. FIG. 3 is an enlarged front view illustrating a schematic configuration of the pipe transporter 12A of the pipe transport device 1.

As illustrated in FIGS. 2 and 3, the pipe transporter 12A includes a vehicle body 121, a front wheel 122, a rear wheel 123, a coupling 124, a support 125, and a receiver 126.

The front wheel 122 is located in a front portion of the vehicle body 121. The rear wheel 123 is located in the rearward direction DRR of the pipe transporter 12A relative to the front wheel 122, in the front-rear direction of the pipe transporter 12A. That is, the rear wheel 123 is located in a rear portion of the vehicle body 121. The pipe transporter 12A is capable of traveling on a rail R laid on the ground by the front wheel 122 and the rear wheel 123.

The coupling 124 is located in a rear portion of the vehicle body 121 in the front-rear direction of the pipe transporter 12A and fixed to the coupler 120 by fasteners such as bolts and nuts or the like.

The support 125 is detachably supported on the vehicle body 121 and extends in the upward direction DUP of the pipe transporter 12A.

The receiver 126 is located at the upper end of the support 125. The receiver 126 is configured to allow the pipe support 11 to be inserted from above the pipe transporter 12A and fixed therein.

The pipe transporter 12B is the same as the pipe transporter 12A except that the coupling 124 is located in a front portion of the vehicle body 121 in the front-rear direction of the pipe transporter 12B.

The pipe transporters 12A and 12B transfer the pipe 50 supported by the pipe support 11 along the axial direction of the existing pipeline indicated by the white arrow in FIG. 1, while supporting the pipe support 11 in the existing pipeline.

As described above, the pipe transport device 1 is a device for transporting the pipe 50 to be installed in the existing pipeline. The pipe transport device 1 includes the pipe support 11 that is a rod-shaped structure and penetrates the pipe to support the pipe, the pipe having flexibility, and the pipe transporters 12A and 12B detachably supporting the pipe support 11 and configured to transfer the supported pipe support 11. In the existing pipeline, the pipe transporters 12A and 12B transfer the pipe 50 supported by the pipe support 11 along the axial direction of the pipeline, in the state where the pipe transporters 12A and 12B support the pipe support 11.

In the configuration described above, the pipe transporters 12A and 12B detachably support the pipe support 11. Accordingly, the pipe support 11 can be inserted into the pipe 50 in a state where the pipe support 11 is detached from the pipe transporters 12A and 12B. The pipe transporters 12A and 12B can also support the pipe support 11 in the state where the pipe support 11 penetrates the pipe 50 to support the pipe 50. In this manner, the flexible pipe 50 is supported by the pipe support 11 in the state where the pipe support 11 penetrates the pipe 50. Accordingly, the posture of the pipe 50 during transfer can be stabilized. This can prevent contact of the pipe 50 with the existing pipeline during transfer.

Since the pipe support 11 penetrates the pipe 50, after the pipe 50 is transported to a predetermined position in the existing pipeline, the pipe support 11 is detached from the pipe transporters 12A and 12B, and in this state, the pipe support 11 can be easily pulled out from the pipe 50.

As described above, in this configuration, since the flexible pipe 50 is supported by the pipe support 11 in the state of being penetrated by the pipe support 11, the posture of the pipe 50 during transfer can be stabilized. In addition, in the above configuration, the pipe support 11 can be easily pulled out from the pipe 50 in the state where the pipe support 11 is detached from the pipe transporters 12A and 12B. Thus, high workability is obtained in pulling out the pipe support 11 from the pipe 50.

In the manner described above, the flexible pipe 50 can be efficiently transferred in a stable posture in the pipeline.

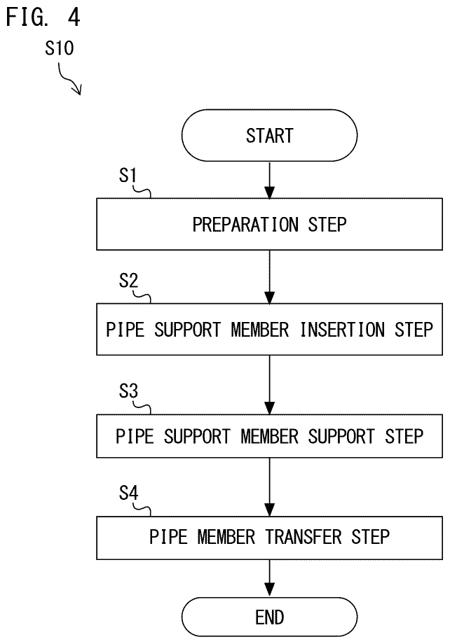

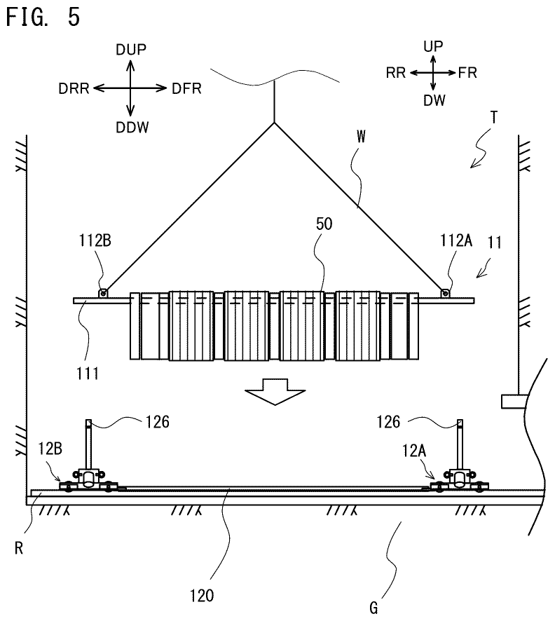

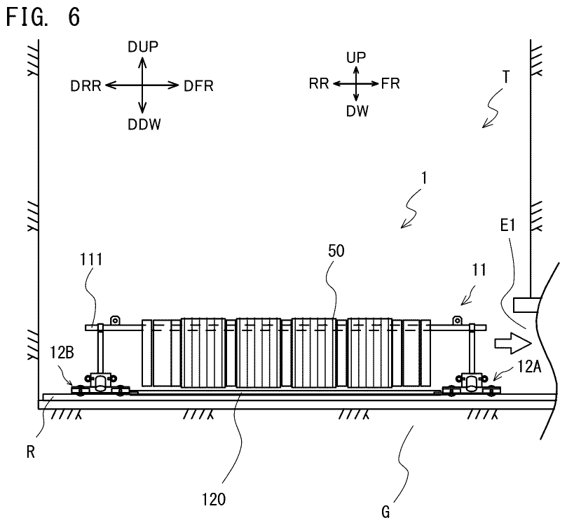

With reference to FIGS. 4 through 6, a piping method for installing a pipe in an existing pipeline will be described. FIG. 4 is a flowchart showing process steps of a piping method S10 according to the first example embodiment. FIG. 5 is a view for describing an operation of attaching the pipe 50 suspended by a wire rope to the pipe transporters 12A and 12B. FIG. 6 is a view for describing a state where the pipe support 11 is supported by the pipe transporters 12A and 12B.

As illustrated in FIG. 4, the piping method S10 includes a preparation step S1, a pipe support insertion step S2, a pipe support supporting step S3, and a pipe transfer step S4.

First, in the preparation step S1, the pipe transporters 12A and 12B coupled to each other by the coupler 120 are prepared on the rail R laid on a bottom G of a shaft T.

In the next pipe support insertion step S2, the pipe support 11 is inserted into the flexible pipe 50. In the pipe support insertion step S2, as illustrated in FIG. 5, in the state where the pipe support 11 is inserted into the pipe 50, a wire rope W is stretched between the anchors 112A and 112B located at both ends of the rod-shaped portion 111 of the pipe support 11. Then, a slinging operation of the wire rope W is performed on an unillustrated hook of a crane. The thus-slung pipe 50 is lowered into the shaft T by the crane.

In the pipe support supporting step S3, the pipe 50 is further lowered in the shaft T in the downward direction as indicated by the white arrow in FIG. 5 so that the pipe transporters 12A and 12B support the pipe support 11 as illustrated in FIG. 6. More specifically, the pipe support 11 is inserted into the receivers 126 of the pipe transporters 12A and 12B from above the pipe transporters 12A and 12B.

In the pipe transfer step S4, the pipe transport device 1 is advanced into an existing pipeline from an opening E1 of the existing pipeline located at the bottom G of the shaft T. That is, in the pipe transfer step S4, the pipe 50 supported by the pipe support 11 is transferred by the pipe transporters 12A and 12B along the axial direction of the pipeline indicated by the white arrow in FIG. 6, in the existing pipeline.

As described above, the piping method S10 is a method for installing the pipe 50 in the existing pipeline. The piping method S10 includes the pipe support insertion step S2 of inserting the pipe support 11 into the flexible pipe 50, the pipe support supporting step S3 of supporting the pipe support 11 by the pipe transporters 12A and 12B, and the pipe transfer step S4 of transferring by the pipe transporters 12A and 12B, in the existing pipeline, the pipe 50 supported by the pipe support 11 along the axial direction of the pipeline.

In the configuration described above, in the state where the pipe support 11 penetrates the pipe 50 to support the pipe 50, the pipe support 11 can be transferred by the pipe transporters 12A and 12B. Accordingly, the posture of the pipe 50 during transfer can be stabilized. This can prevent contact of the pipe 50 with the existing pipeline during transfer.

Since the pipe support 11 penetrates the pipe 50, after the pipe 50 is transported to a predetermined position in the existing pipeline, the pipe support 11 is detached from the pipe transporters 12A and 12B, and in this state, the pipe support 11 can be easily pulled out from the pipe 50.

In the manner described above, in the configuration described above, the flexible pipe 50 is supported by the pipe support 11 in the state of being penetrated by the pipe support 11. Accordingly, the posture of the pipe 50 during transfer can be stabilized. In addition, in the above configuration, the pipe support 11 can be easily pulled out from the pipe 50 in the state where the pipe support 11 is detached from the pipe transporters 12A and 12B. As a result, high workability is obtained.

In the manner described above, the flexible pipe 50 can be efficiently transferred in a stable posture in the pipeline.

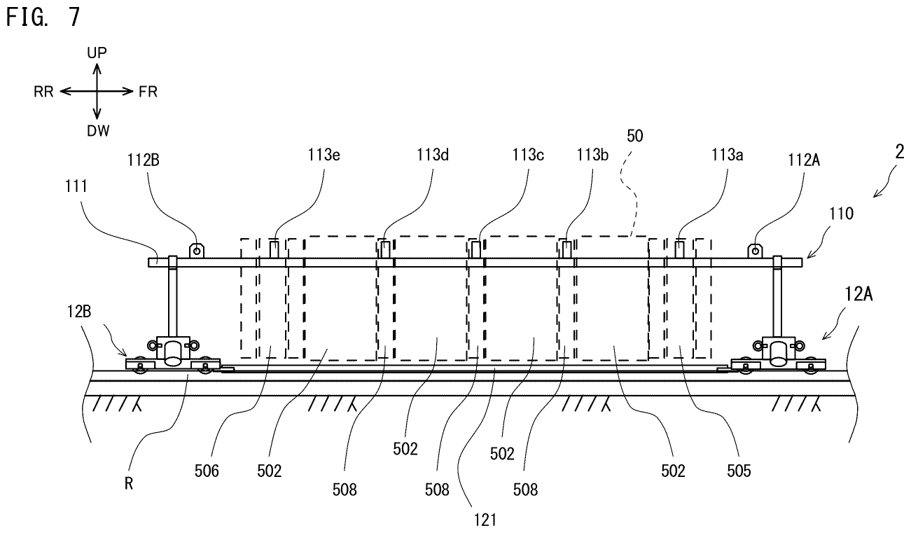

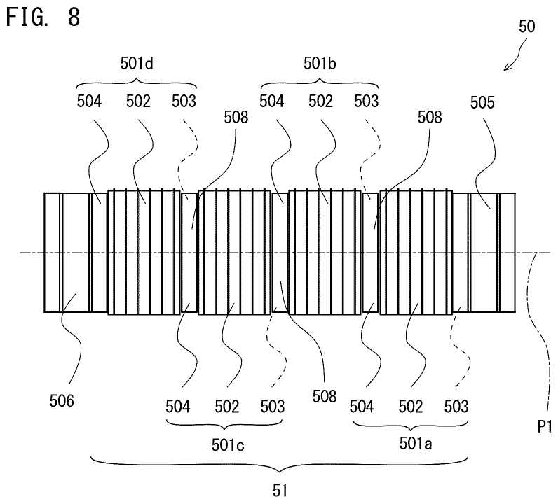

FIG. 7 is a side view illustrating a schematic configuration of a pipe transport device 2 according to a second example embodiment of the present invention. FIG. 8 is a side view illustrating a schematic configuration of a pipe 50 according to the second example embodiment. The pipe transport device 2 according to the second example embodiment is different from the pipe transport device 1 according to the first example embodiment in supporting a coupling 508 of the pipe 50. In the following description, components similar to those of the first example embodiment are denoted by the same reference characters and will not be described again, and only components different from those of the first example embodiment will be described.

As illustrated in FIG. 8, more specifically, the pipe 50 includes a coupled body 51 including a plurality of bellows pipes 501a through 501d that are coupled in series, an end portion 505 located at one end of the coupled body 51 in an axial direction P1 of the pipe 50, and an end portion 506 located at the other end.

Each of the bellows pipes 501a through 501d includes a displacement portion 502, a joint portion 503 located at one end of the displacement portion 502 in the axial direction P1 of the pipe 50, and a joint portion 504 located at the other end. The displacement portion 502 has a bellows structure. Accordingly, the displacement portion 502 has extensibility and flexibility.

The end portion 505 is attached to the joint portion 503 of the bellows pipe 501a located at one end of the coupled body 51. The end portion 506 is attached to the joint portion 504 of the bellows pipe 501d located at the other end of the coupled body 51.

Adjacent pipes are coupled to each other by the joint portion of one pipe and the joint portion of the other pipe. For example, the coupling 508 includes the joint portion 504 of the bellows pipe 501a and the joint portion 503 of the bellows pipe 501b.

In this manner, the pipe 50 includes the plurality of displacement portions 502 and the plurality of couplings 508. The outer diameter of each displacement portion 502 is larger than the outer diameter of each coupling 508.

As illustrated in FIG. 7, the pipe transport device 2 includes a pipe support 110.

The pipe support 110 includes a rod-shaped portion 111, a plurality of projection portions 113a through 113e, and anchors 112A and 112B.

The rod-shaped portion 111 and the anchors 112A and 112B are already described in the first example embodiment, and thus, will not be described again here.

As illustrated in FIG. 7, each of the plurality of projection portions 113a through 113e projects in a direction intersecting with the one direction with respect to the rod-shaped portion 111.

In a state where the pipe support 110 penetrates the pipe 50 to support the pipe 50, the plurality of projection portions 113b through 113d support the couplings 508 in the pipe 50. The projection portion 113a supports the end portion 505 of the pipe 50. The projection portion 113e supports the end portion 506 of the pipe 50.

As described above, the pipe support 110 includes the rod-shaped portion 111 extending in one direction, and the projection portions 113b through 113d each projecting in the direction intersecting with the one direction with respect to the rod-shaped portion 111 and supporting the couplings 508 in the pipe 50. The pipe support 110 also includes the projection portions 113a and 113e supporting the end portions 505 and 506 in the pipe 50.

In the configuration described above, the projection portions 113a through 113e support the couplings 508 of the pipe 50 and other structures. Accordingly, the pipe support 110 can support the couplings 508 that are not likely to be displaced and other structures by the projection portions 113b through 113d while avoiding the displacement portions 502 that are likely to be displaced in the pipe 50. Thus, it is possible to prevent deformation of the pipe 50 in transferring the pipe 50 in the state where the pipe support 110 penetrates the pipe 50 to support the pipe 50.

In the configuration described above, the positions of the projection portions 113a through 113e in the one direction may be adjustable relative to the rod-shaped portion 111. Accordingly, the positions of the projection portions 113a through 113e can be adjusted in accordance with the positions of the couplings 508 of the pipe 50 and other structures. As a result, versatility of the pipe transport device 2 can be enhanced.

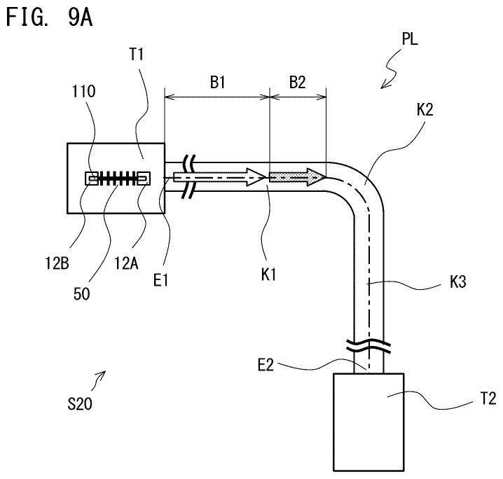

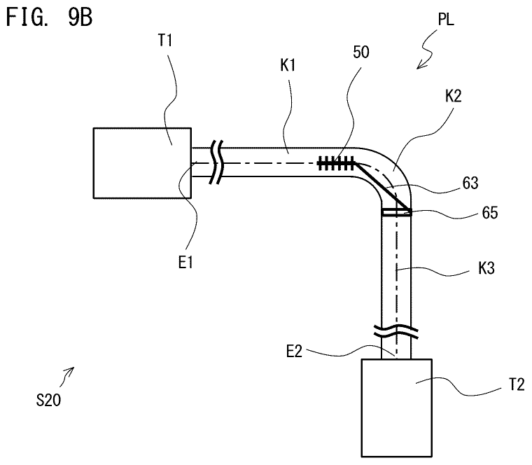

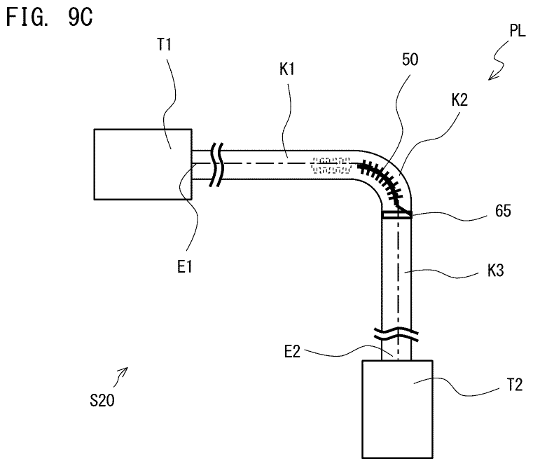

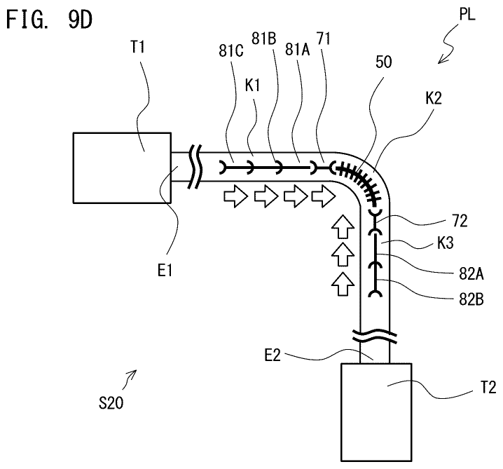

With reference to FIGS. 9A through 9D, an outline of a piping method for installing a pipe in an existing pipeline will be described. FIG. 9A is a view schematically illustrating a pipe transfer step of a piping method S20 according to the second example embodiment. FIG. 9B is a view schematically illustrating a support ring setting step, a winding device disposing step, and a coupling step of the piping method S20 according to the second example embodiment. FIG. 9C is a view schematically illustrating a pulling step of the piping method S20 according to the second example embodiment. FIG. 9D is a view schematically illustrating a piping step for a coupling collar and a straight pipe of the piping method S20 according to the second example embodiment.

The piping method S20 according to the second example embodiment is different from the piping method S10 according to the first example embodiment in disposing the pipe 50 in a pipeline including a bent pipe portion. In the following description, components similar to those of the first example embodiment are denoted by the same reference characters and will not be described again, and only components different from those of the first example embodiment will be described.

As illustrated in FIG. 9A, an existing pipeline PL as a target of piping construction includes a first straight pipe portion K1, a bent pipe portion K2, and a second straight pipe portion K3. The first straight pipe portion K1 has an opening E1 connected to a shaft T1 at one end. The other end of the first straight pipe portion K1 is connected to one end of the bent pipe portion K2. The other end of the bent pipe portion K2 is connected to one end of the second straight pipe portion K3. The bent pipe portion K2 connects the first straight pipe portion K1 and the second straight pipe portion K3 to each other at an angle of 90°. The second straight pipe portion K3 has an opening E2 connected to a shaft T2 at the other end.

As illustrated in FIG. 9A, in the piping method S20, first, the pipe support 110 supporting the pipe 50 is supported by the pipe transporters 12A and 12B in the shaft T1. Then, the pipe 50 supported by the pipe support 110 is advanced by the pipe transporters 12A and 12B to the opening E1 of the first straight pipe portion K1 connected to the shaft T1. The pipe transporters 12A and 12B are conveyed in the traveling direction by a self-propelled vehicle such as an unillustrated battery car coupled to the rear of the pipe transporter 12B, for example. The pipe 50 that has entered the first straight pipe portion K1 from the opening E1 is transferred along the axial direction of the first straight pipe portion K1 (axial direction of the pipeline) indicated by the chain line in FIG. 9A, up to the front of the bent pipe portion K2.

Subsequently, as illustrated in FIG. 9B, the pipe support 110 is pulled p out from the pipe 50, and the pipe transporters 12A and 12B are removed. A support ring 65 is set in the second straight pipe portion K3, and the pipe 50 and the support ring 65 are coupled to each other by a wire 63. Here, the wire 63 is wound by a winding device or the like so that the pipe 50 is thereby pulled toward the support ring 65.

Accordingly, as illustrated in FIG. 9C, the pipe 50 moves to the other side of the bent pipe portion K2, while bending along a curve of the bent pipe portion K2. Thereafter, the support ring 65 and the wire 63 are removed.

Further, as illustrated in FIG. 9D, a coupling collar 71 and PN-type pipes 81A, 81B, and 81C as straight pipes are sequentially conveyed from the shaft T1 and connected to one end of the disposed pipe 50. A coupling collar 72 and PN-type pipes 82A and 82B are sequentially conveyed from the shaft T2 and connected to the other end of the disposed pipe 50. Accordingly, the pipe 50, the coupling collars 71 and 72, the PN-type pipes 81A, 81B, and 81C, and the PN-type pipes 82A and 82B can be connected in the existing pipeline PL. The type of pipe connected to the pipe 50 is an example for description, and is not limited to that in the above example. Any pipes can be connected to the pipe 50 depending on the shape of the pipeline PL and others.

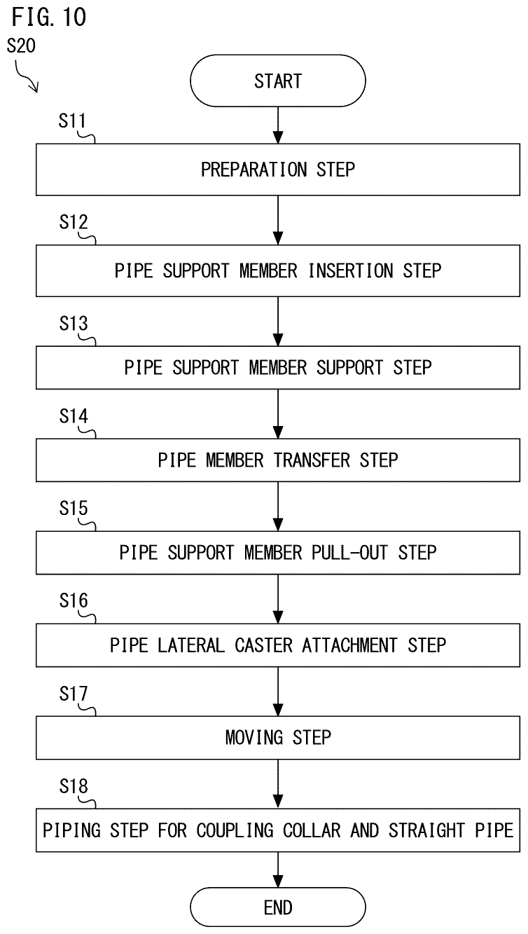

With reference to FIGS. 10 through 24, the piping method S20 will be described in detail. FIG. 10 is a flowchart showing process steps of the piping method S20 according to the second example embodiment. Process steps of the piping method S20 will be described in order below.

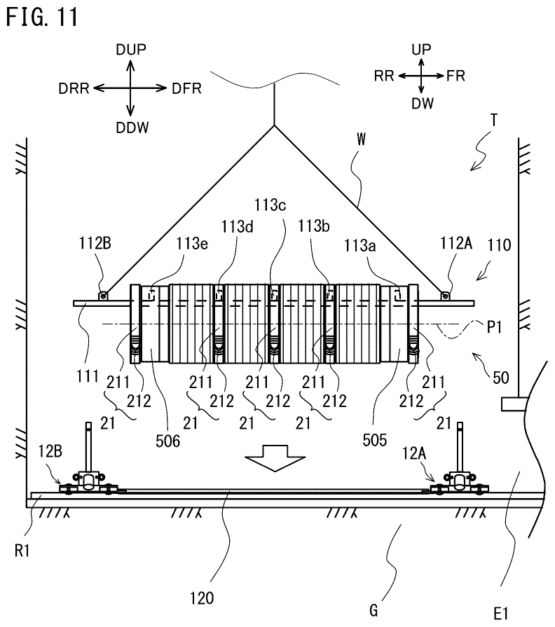

In the preparation step S11, the pipe transporters 12A and 12B coupled to each other by the coupler 120 are prepared on a rail R1 laid on a bottom G of the shaft T1 (see also FIG. 11).

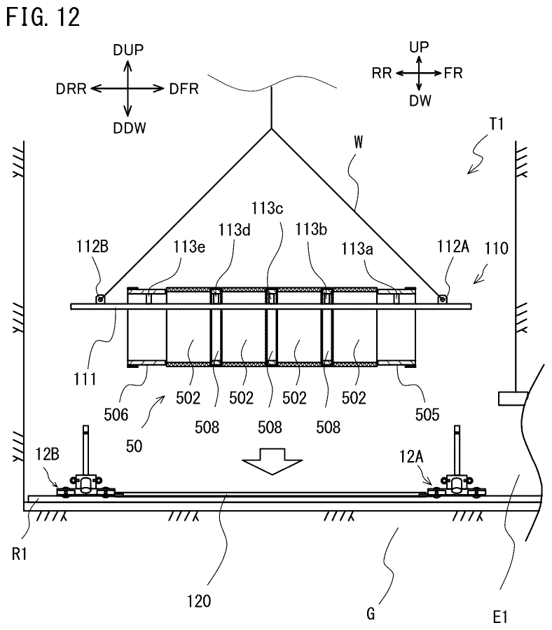

FIG. 11 is a view for describing an operation of attaching the pipe 50 suspended by a wire rope to the pipe transporters 12A and 12B. FIG. 12 is a view illustrating the pipe 50 in FIG. 11 in a vertical cross section.

In the pipe support insertion step S12, as illustrated in FIGS. 11 and 12, the pipe support 110 is inserted into the pipe 50 to which a caster band 21 is attached. The caster bands 21 are attached to the radially outer side of the couplings 508 and the end portions 505 and 506. Each of the caster bands 21 includes an annular body 211 and a pair of casters 212. The center axis of the annular body 211 coincides with the axial direction P1 of the pipe 50. The caster band 21 will be described in detail later. The pipe support 110 is located in the pipe 50 such that the projection portions 113b through 113d of the pipe support 110 support the couplings 508 of the pipe 50. The pipe support 110 is located in the pipe 50 such that the projection portions 113a and 113e of the pipe support 110 support the end portions 505 and 506 of the pipe 50.

In addition, in the pipe support insertion step S2, as illustrated in FIGS. 11 and 12, in the state where the pipe support 110 is inserted into the pipe 50, a wire rope W is stretched between the anchors 112A and 112B located at both ends of the rod-shaped portion 111 of the pipe support 110. Then, a slinging operation of the wire rope W is performed on an unillustrated hook of a crane. The thus-slung pipe 50 is lowered into the shaft T1 by the crane.

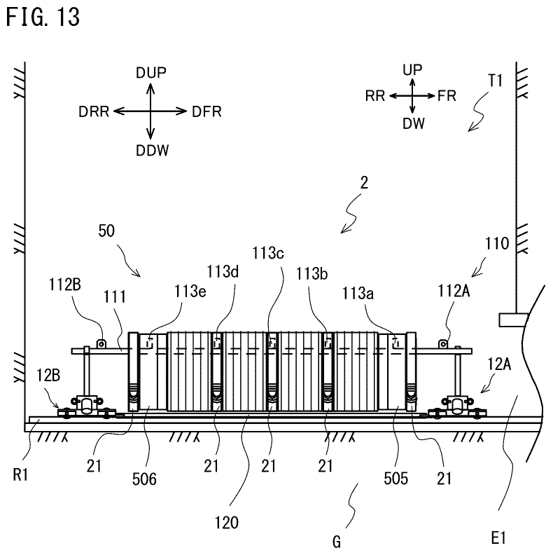

FIG. 13 is a view for describing a state where the pipe support 110 is supported by the pipe transporters 12A and 12B.

In the pipe support supporting step S13, the pipe support 110 is supported by the pipe transporters 12A and 12B. The pipe transporters 12A and 12B support the pipe support 110 in the state where the pipe support 110 penetrates the pipe 50. In the state where the pipe support 110 penetrates the pipe 50, the projection portions 113b through 113d of the pipe support 110 support the couplings 508 in the pipe 50. In the other respects, the pipe support supporting step S13 is the same as the pipe support supporting step S3 described above. Therefore, the pipe support supporting step S13 will not be described in detail again.

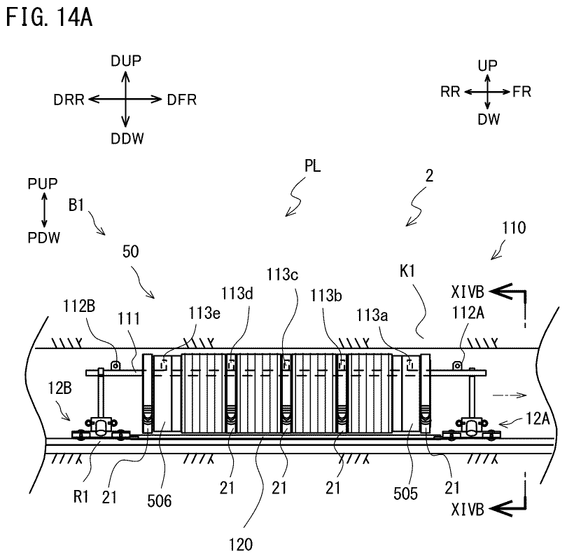

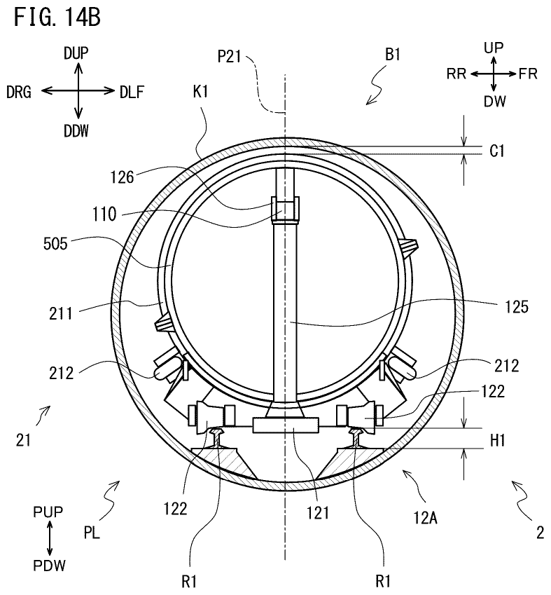

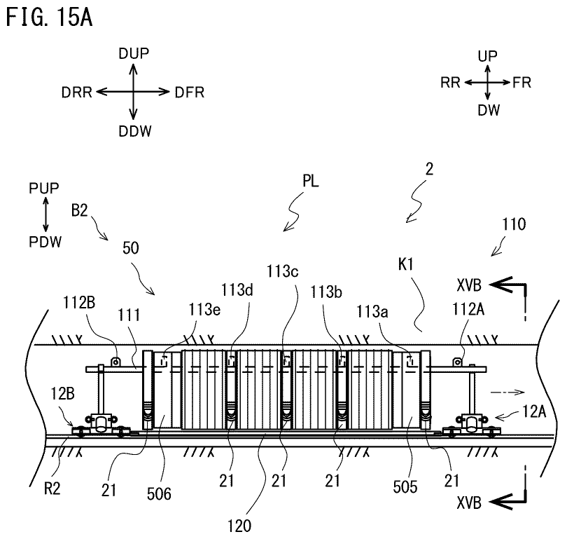

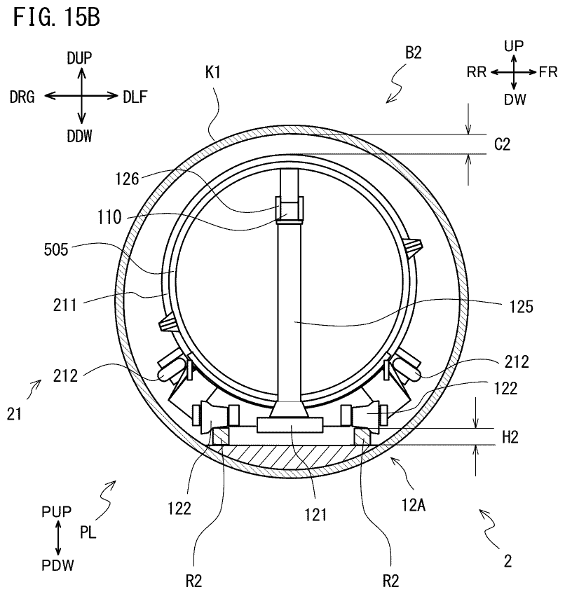

FIG. 14A is a view illustrating a portion of the pipe transfer step S14. FIG. 14B is an enlarged cross-sectional view taken along line XIVB-XIVB in FIG. 14A. FIG. 15A is a view illustrating another portion of the pipe transfer step S14. FIG. 15B is an enlarged cross-sectional view taken along line XVB-XVB in FIG. 15A.

In the pipe transfer step S14, in the first straight pipe portion K1, the pipe 50 supported by the pipe support 110 is transferred by the pipe transport device 2 including the pipe transporters 12A and 12B along the axial direction of the first straight pipe portion K1 indicated by a chain line arrow in FIG. 14A. As described above, the pipe transport device 2 moves by a self-propelled vehicle (not shown) coupled to the rear of the pipe transporter 12B, in the front-rear direction of the pipe transport device 2. Here, with reference to FIG. 9A again, a pipe transfer section B1 and a pipe mount section B2 will be described.

As illustrated in FIGS. 9A, 14A, and 14B, a rail R1 with a height H1 is laid in the pipe transfer section B1 in the first straight pipe portion K1, starting from the shaft T1. A clearance between the inner wall of the first straight pipe portion K1 and the upper end of the pipe 50 conveyed by the pipe transport device 2 at this time is C1.

As illustrated in FIGS. 9A, 15A, and 15B, a rail R2 with a height H2 is laid in the pipe mount section B2 located ahead of the pipe transfer section B1 in the first straight pipe portion K1. The height H2 of the rail R2 is lower than the height H1 of the rail R1. A clearance between the inner wall of the first straight pipe portion K1 and the upper end of the pipe 50 conveyed by the pipe transport device 2 at this time is C2. The clearance C2 is larger than the clearance C1. Specifically, in the pipe mount section B2, the conveyed pipe 50 is unloaded from the pipe transport device 2, which will be described in detail later. The length of the pipe mount section B2 is preferably greater than or equal to the entire length of the pipe transport device 2 in the front-rear direction.

As FIG. 14B, the caster band 21 is attached to the radially outer side of the end portion 505. The caster band 21 includes the annular body 211 and the pair of casters 212. The annular body 211 is located on the entire outer circumferential surface of the end portion 505. As illustrated in FIG. 14B, the pair of casters 212 is positioned at the lower portion of the annular body 211 in the front view of the pipe transport device 2, and at the same angular position relative to a vertical axis P21 passing through the center of the annular body 211. The pair of casters 212 is located radially outward of the annular body 211.

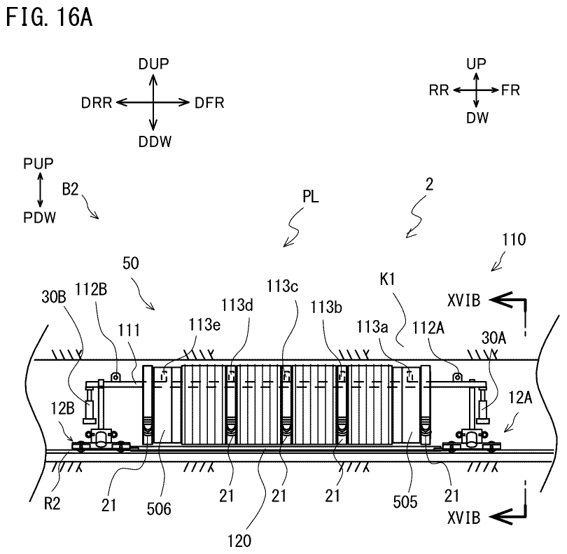

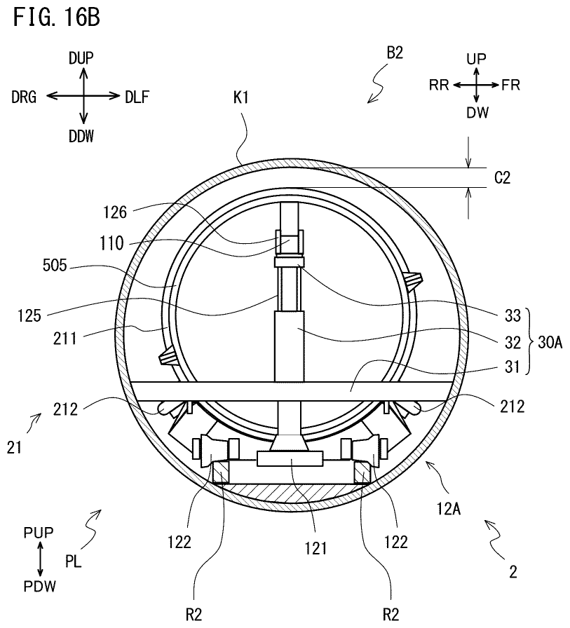

With reference to FIGS. 16A through 20B, the pipe support pull-out step S15 will be described. In the pipe support pull-out step S15, in a state where the pipe support 110 is detached from the pipe transporters 12A and 12B, the pipe support 110 is pulled out from the pipe 50. The pipe support pull-out step S15 includes a setting operation of pipe lifting jigs 30A and 30B, a pipe lifting operation, a pull-out operation of the pipe transporters 12A and 12B, a mount operation of the pipe 50, and a pull-out operation. The steps will be specifically described below.

FIG. 16A is a view for describing a setting operation of the pipe lifting jigs 30A and 30B in the pipe support pull-out step S15. FIG. 16B is an enlarged cross-sectional view taken along line XVIB-XVIB in FIG. 16A.

As illustrated in FIGS. 16A and 16B, the pipe lifting jigs 30A and 30B are set in the first straight pipe portion K1. The pipe lifting jigs 30A and 30B can be realized by, for example, hydraulic jacks. The pipe lifting jig 30A is set at the forward end of the pipe support 110 in the front-rear direction of the pipe transport device 2. The pipe lifting jig 30B is set at the rearward end of the pipe support 110 in the front-rear direction of the pipe transport device 2. Since the pipe lifting jigs 30A and 30B have basically the same configuration, a schematic configuration of the pipe lifting jig 30A will be described as an example.

The pipe lifting jig 30A includes a base portion 31, an elevation portion 32, and a receiving base 33. The base portion 31 is set at both side surfaces of a lower portion of the first straight pipe portion K1. The base portion 31 supports the elevation portion 32. The elevation portion 32 supports the receiving base 33 such that the receiving base 33 is vertically movable in the top-bottom direction of the existing pipeline PL. The receiving base 33 supports the pipe support 110.

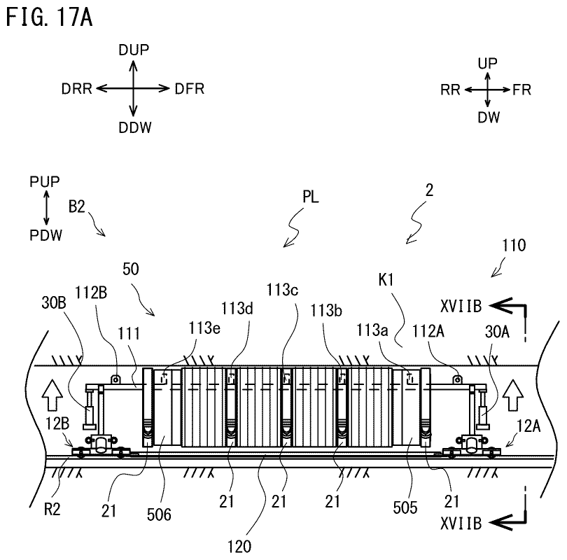

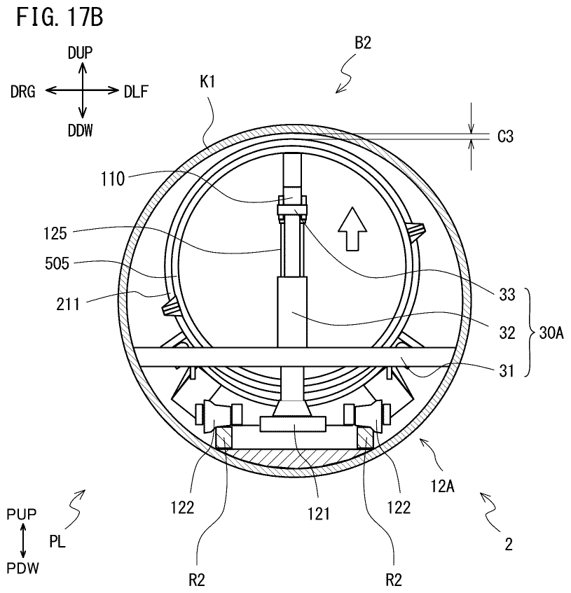

FIG. 17A is a view for describing a pipe lifting operation in the pipe support pull-out step S15. FIG. 17B is an enlarged cross-sectional view taken along line XVIIB-XVIIB in FIG. 17A.

As illustrated in FIGS. 17A and 17B, the pipe lifting jigs 30A and 30B lift the pipe support 110 with respect to the pipe transporters 12A and 12B. Specifically, the elevation portions 32 of the pipe lifting jigs 30A and 30B lift the receiving base 33 supporting the pipe support 110. Accordingly, the pipe support 110 is separated from the pipe transporters 12A and 12B. As indicated by the white arrow in FIG. 17B, the pipe 50 is lifted upward in the top-bottom direction of the pipe transport device 2. A clearance between the inner wall of the first straight pipe portion K1 and the upper end of the pipe 50 conveyed by the pipe transport device 2 at this time is C3.

In the manner described above, in the pipe mount section B2, since the rail R2 with a height lower than that of the rail R1 is laid, a clearance for lifting the pipe 50 can be enlarged. Accordingly, even in lifting the pipe 50, the clearance C3 can be maintained.

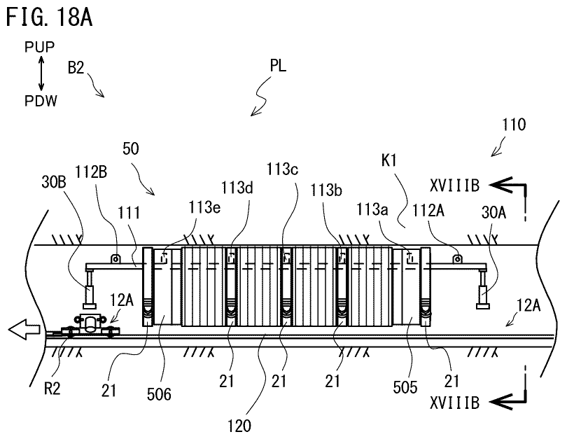

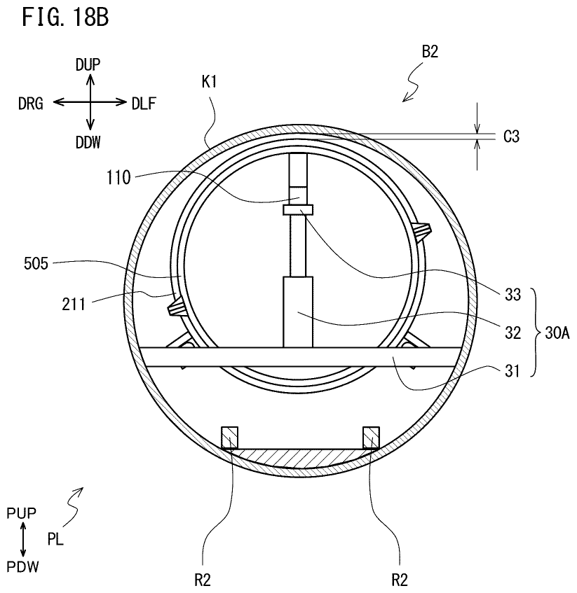

FIG. 18A is a view for describing a pull-out operation of the pipe transporters 12A and 12B in the pipe support pull-out step S15. FIG. 18B is an enlarged cross-sectional view taken along line XVIIIB-XVIIIB in FIG. 18A.

As illustrated in FIGS. 18A and 18B, in the state where the pipe support 110 is separated from the pipe transporters 12A and 12B, the pipe transporters 12A and 12B are retracted relative to the pipe 50. Specifically, the supports 125 are detached from the pipe transporters 12A and 12B and removed. Subsequently, an unillustrated self-propelled vehicle is retracted so that the pipe transporters 12A and 12B are thereby moved in the direction to the shaft T1 indicated by the white arrow in FIG. 18A.

In the configuration described above, the retracted pipe transporters 12A and 12B can be collected. Thus, the collected pipe transporters 12A and 12B can be reused.

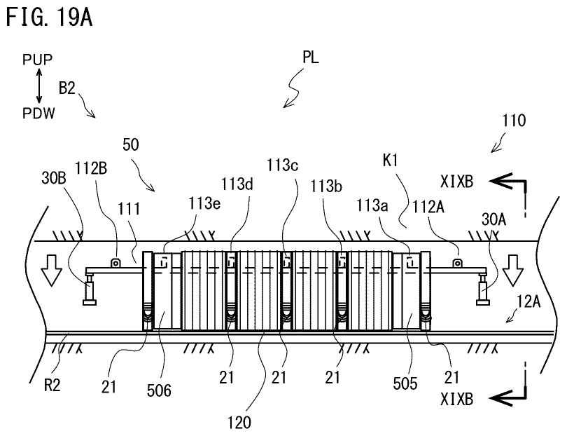

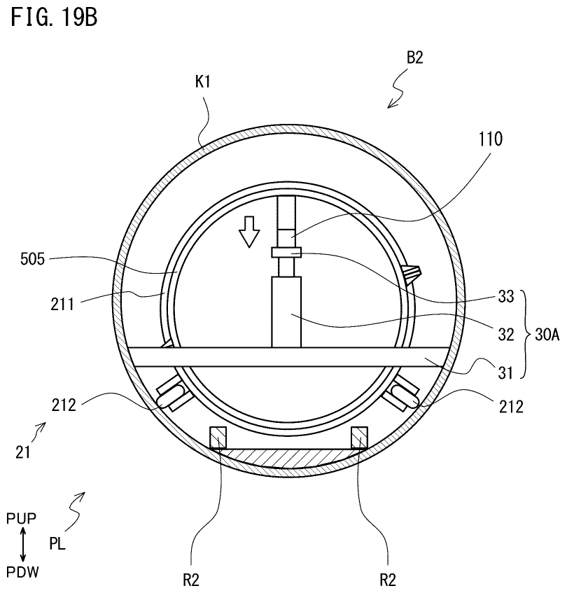

FIG. 19A is a view for describing a mount operation of the pipe 50 in the pipe support pull-out step S15. FIG. 19B is an enlarged cross-sectional view taken along line XIXB-XIXB in FIG. 19A.

As illustrated in FIGS. 19A and 19B, the pipe lifting jigs 30A and 30B lower the receiving bases 33 supporting the pipe support 110. Specifically, the elevation portions 32 of the pipe lifting jigs 30A and 30B lower the receiving bases 33 supporting the pipe support 110. Accordingly, the pipe 50 moves downward in the existing pipeline PL indicated by the white arrow in FIG. 19B. As illustrated in FIG. 19B, the elevation portions 32 of the pipe lifting jigs 30A and 30B lower the pipe 50 until the casters 212 of the caster bands 21 contact a lower portion of the inner wall of the first straight pipe portion K1.

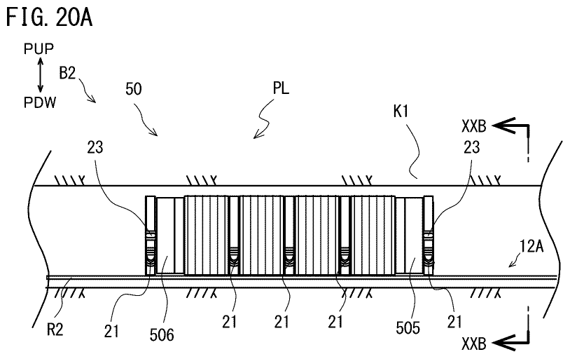

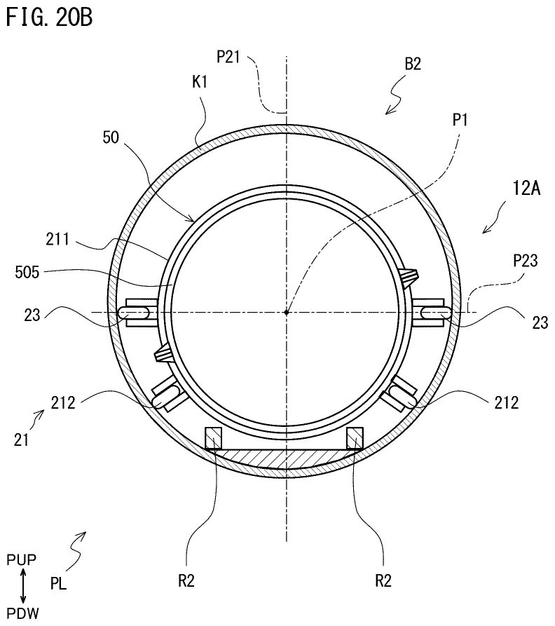

FIG. 20A is a view for describing a pull-out operation in the pipe support pull-out step S15. FIG. 20B is an enlarged cross-sectional view taken along line XXB-XXB in FIG. 20A.

As illustrated in FIGS. 20A and 20B, in the state where the pipe 50 is installed in the existing pipeline PL as described above, the pipe support 110 is pulled out from the pipe 50 and the pipe lifting jigs 30A and 30B are removed.

In the configuration described above, while the pipe support 110 is lifted relative to the pipe transporters 12A and 12B by using the pipe lifting jigs 30A and 30B, the pull-out work of the pipe support 110 can be performed. After the pipe support 110 is pulled out from the pipe 50, the pipe 50 can be lowered by the pipe lifting jigs 30A and 30B. In this manner, the pipe lifting jigs 30A and 30B can be used to efficiently perform the pull-out work of the pipe support 110 and the disposing work of the pipe 50. Accordingly, the pull-out work of the pipe support 110 can be more efficiently performed.

With reference to FIGS. 20A and 20B, a pipe lateral caster attachment step (caster attachment step) S16 will be described. In the pipe lateral caster attachment step S16, as illustrated in FIGS. 20A and 20B, pipe lateral casters (casters) 23 configured to move the pipe 50 in the existing pipeline PL are attached to the outer surface of the pipe 50. Specifically, the pair of pipe lateral casters 23 is attached to the caster band 21 attached to the end portion 505. As illustrated in FIG. 20B, the pair of pipe lateral casters 23 is located in the direction in which a lateral axis P23 of the annular body 211 extends. The lateral axis P23 of the annular body 211 is orthogonal to the vertical axis P21 passing through the center of the annular body 211 in the front view of the pipe transport device 2 and the axial direction P1 of the pipe 50 (i.e., the center axis of the annular body 211). The pair of pipe lateral casters 23 is located radially outward of the annular body 211.

In the configuration described above, by attaching the pipe lateral casters 23 to the outer surface of the pipe 50, the pipe 50 can be easily moved in the existing pipeline PL. Thus, in a moving step below, a force of pushing the pipe 50 into the bent pipe portion K2 can be reduced.

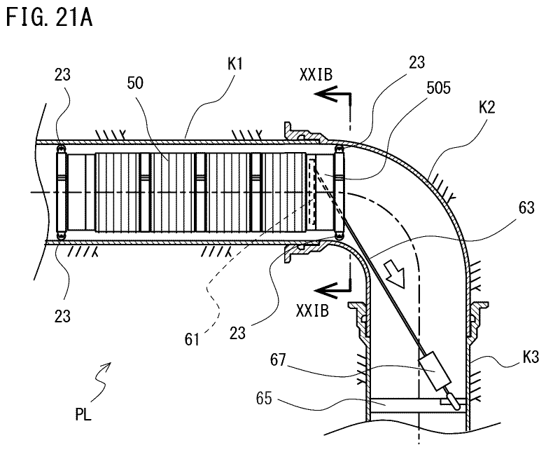

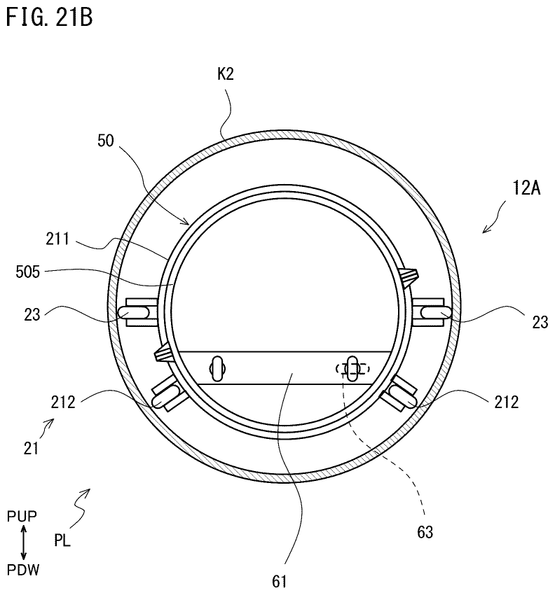

With reference to FIGS. 21A through 23C, a moving step S17 will be described.

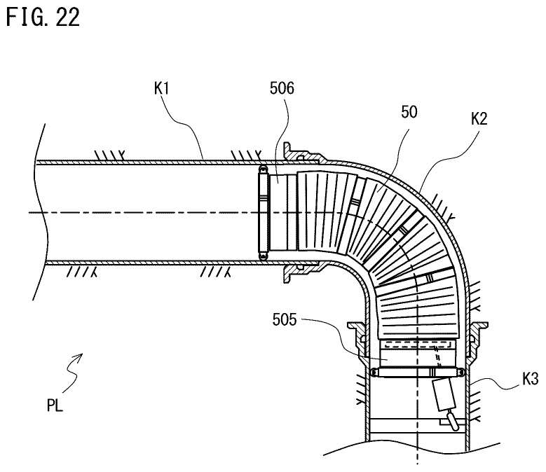

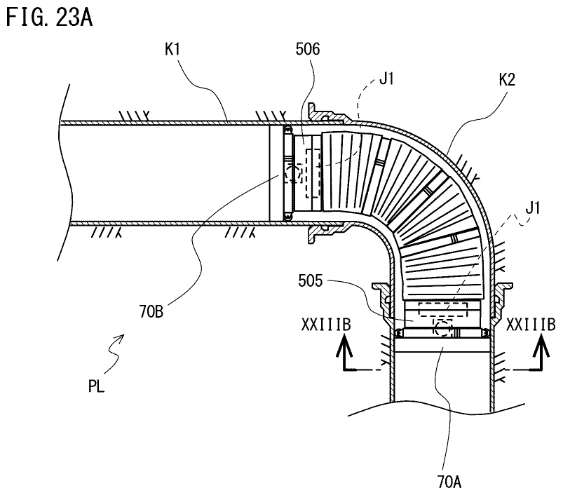

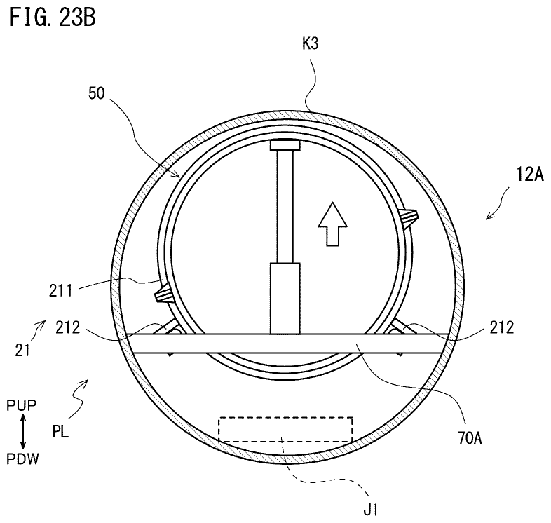

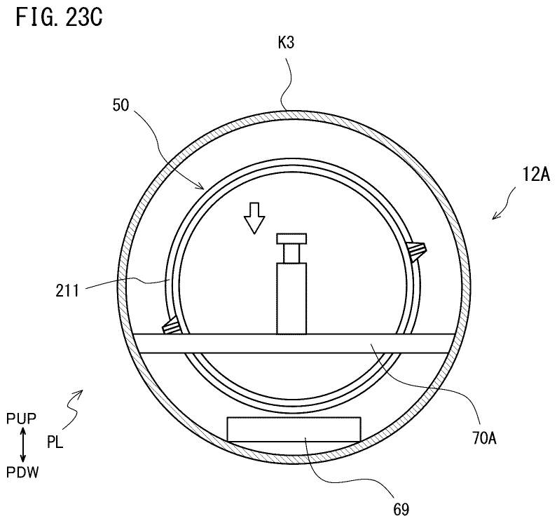

FIG. 21A is a piping diagram for describing the moving step S17. FIG. 21B is an enlarged cross-sectional view taken along line XXIB-XXIB in FIG. 20A. FIG. 22 is a piping diagram illustrating a state after pulling of the pipe. FIG. 23A is a piping diagram illustrating a state at setting of lifting jigs. FIG. 23B is an enlarged cross-sectional view taken along line XXIIIB-XXIIIB in FIG. 23A. FIG. 23C is a view corresponding to FIG. 23B and illustrating a state at setting of a crosstie.

In the moving step S17, the pipe 50 is pulled from the second straight pipe portion K3 so that the pipe 50 is moved to the other end of the bent pipe portion K2 while bending along the curve of the bent pipe portion K2. Specifically, the moving step S17 includes the following work. A support ring 65 is set in the second straight pipe portion K3 (support ring setting step). As the support ring 65, a technique described in Japanese Patent Application Publication No. 2021-092291, for example, can be used. The technique described in Japanese Patent Application Publication No. 2021-092291 can be used. Subsequently, a winding device 67 such as a lever hoist or a winch is disposed on the support ring 65 (winding device disposing step). A reaction plate 61 is attached to the inside of the end portion 505 of the pipe 50, and the reaction plate 61 of the pipe 50 is coupled to the winding device 67 by a wire 63 (coupling step).

Thereafter, the wire 63 is wound by the winding device 67, thereby pulling the pipe 50 toward the support ring 65 as indicated by the white arrow in FIG. 21A. Accordingly, the pipe 50 moves along the axial direction of the existing pipeline PL indicated by the chain line in FIG. 21A. As a result, as illustrated in FIG. 22, the pipe 50 moves to the other end of the bent pipe portion K2. That is, the end portion 505 of the pipe 50 reaches the other end of the bent pipe portion K2. The use of the reaction plate 61 and the support ring 65 can obtain a reaction force in the pipeline PL. This eliminates the necessity for supplying a force of pulling the pipe 50 from the outside of the shaft.

After the pull-in work of the pipe 50 is completed as described above, the reaction plate 61, the wire 63, the support ring 65, and the winding device 67 are removed. The pipe lateral casters 23 are removed from the caster band 21.

Further, as described below, mount work of the pipe 50 is performed. First, as illustrated in FIGS. 23A and 23B, a pipe lifting jig 70A is set in the second straight pipe portion K3, whereas a pipe lifting jig 70B is set in the first straight pipe portion K1. That is, the pipe lifting jig 70A is set at the end portion 505 located at one end of the pipe 50, and the pipe lifting jig 70B is set at the end portion 506 located at the other end of the pipe 50. Since the pipe lifting jigs 70A and 70B have basically similar configurations, the pipe lifting jig 70A will be described here as an example.

Thereafter, the pipe lifting jigs 70A and 70B lift the pipe 50 upward as indicated by the white arrow in FIG. 23B. FIG. 23B illustrates a lifting state where the pipe 50 is lifted by the pipe lifting jig 70A. In this state, the pair of casters 212 is detached from the annular body 211 of the caster band 21. A steel crosstie 69 is set at a steel crosstie set position J1. The pipe 50 lifted by the pipe lifting jigs 70A and 70B is lowered downward as indicated by the white arrow in FIG. 23C so that the pipe 50 is thereby set above the steel crosstie 69.

In the manner described above, the mount work of the pipe 50 is completed.

In a piping step for a coupling collar and a straight pipe S18, a coupling collar and a straight pipe are arranged, as described with reference to FIG. 9D.

As described above, the piping method S20 includes the pipe support pull-out step S15 and the moving step S17 after the pipe transfer step S14. In the pipe support pull-out step S15, in the state where the pipe support 110 is detached from the pipe transporters 12A and 12B, the pipe support 110 is pulled out from the pipe 50. The pipeline PL includes the first straight pipe portion K1 having an opening at one end, the bent pipe portion K2 having one end connected to the other end of the first straight pipe portion K1, and the second straight pipe portion K3 having one end connected to the other end of the bent pipe portion K2. In the moving step S17, the pipe 50 is pulled from the second straight pipe portion K3 of the pipeline PL so that the pipe 50 thereby moves to the other end of the bent pipe portion K2 while bending along a curve of the bent pipe portion K2.

In the configuration described above, in the case of the pipeline PL including the bent pipe portion K2, the pipe 50 is pulled from the second straight pipe portion K3 of the pipeline PL so that the pipe 50 moves to the other end of the bent pipe portion while bending along the curve of the bent pipe portion.

With the configuration described above, the flexible pipe can be bent and piped in the bent pipe portion. Thus, the pipe can be provided not only in the straight pipe portion, but also in the bent pipe portion in a bent state, and the piping method capable of piping the pipe in various existing pipelines can be achieved. In addition, a pipeline including the bent pipe portion K2, which has been difficult to renew unless a shaft is constructed, can be easily renewed. That is, in the configuration described above, construction can be performed even on the bent pipe portion K2 where a shaft cannot be constructed due to conditions such as traffic conditions.

Example embodiments of the present invention have been described above, but the above example embodiments are merely examples of the present invention. Thus, the present invention is not limited to the above example embodiments, and the example embodiments may be modified as necessary within a range not departing from the gist of the present invention.

In the example embodiments described above, the pipe transporters 12A and 12B of the pipe transport device 1, 2 are dollies each including the front wheel 122 and the rear wheel 123 for traveling on the rail. Alternatively, the pipe transporter may include a moving mechanism such as a sled, instead of the wheel. The pipe transporter may have a moving mechanism such as a rubber-tired wheel capable of traveling without a rail. The pipe transporter may include a moving mechanism configured to travel on the floor laid in the pipeline or on the bottom of the inner wall of the pipeline. The pipe transporter may be self-propelled.

In the example embodiments described above, the pipe support 11, 110 is a rod-shaped structure. Alternatively, the pipe support may have another shape. For example, the pipe support may have a plate shape or a frame shape, or may be a wire structure.

The example embodiments preferably utilize a so-called pipe-in-pipe technique, for example. Alternatively, example embodiments of the present invention are applicable to other techniques. Example embodiments of the present invention are also applicable to a shield method, for example.

In the second example embodiment, the bent pipe portion K2 connects the first straight pipe portion K1 and the second straight pipe portion K3 to each other at an angle of 90°. Alternatively, the connection angle by the bent pipe portion may be larger than or smaller than 90°. In general, a curve having a connection angle exceeding 22.5° is defined as a sharp curve. Example embodiments of the present invention are also suitably applicable to such a sharp curve. Further, as the pipe diameter increases, a larger pull-in force or a larger insertion force is needed. Example embodiments of the present invention can reduce an insertion force in the bent pipe portion. Thus, example embodiments of the present invention are applicable to the case of using a so-called large diameter pipe for renewing an existing pipeline.

In the second example embodiment, the pipe 50 is pulled using the support ring 65 set in the second straight pipe portion K3 as a reaction force. Alternatively, a technique for obtaining a reaction force without using a support ring can be used. For example, a reaction force may be obtained by fixing a plate for a reaction force to an inner wall of an existing pipeline by welding or the like. Alternatively, a reaction force may be obtained by fixing the plate for a reaction force to the inner wall of the existing pipeline with insertion of the plate for a reaction force into a gap between joints of joint portions of existing pipes.

In the second example embodiment, the displacement portion 502 of the pipe 50 has a bellows structure. Alternatively, the displacement portion of the pipe may be displaceable by a structure other than the bellows structure. For example, the displacement portion of the pipe may have a ball joint structure.

In the second example embodiment, the rail R1 with the height H1 is laid in the pipe transfer section B1 of the first straight pipe portion K1, whereas the rail R2 with the height H2 is laid in the pipe mount section B2. Alternatively, rails with different heights may not be laid in the first straight pipe portion.

In the second example embodiment, the pair of casters 212 is located at specific positions relative to the annular body 211 of the caster band 21. Alternatively, the positions of the casters can be changed as appropriate. The number of casters is not limited to a pair with respect to the caster band, and may be one, or two or more, with respect to the caster band.

In the second example embodiment, a specific number of caster bands 21 are attached to the pipe 50. Alternatively, any number of caster bands may be attached to the pipe.

In the second example embodiment, the pipe lateral caster attachment step S16 that is a caster attachment step is performed next to the pipe support pull-out step S15. Alternatively, it is sufficient to perform the caster attachment step before the moving step. The pipe lateral caster may be attached to the caster band beforehand as long as a sufficient clearance between the inner wall of the existing pipeline and the upper end of the pipe is maintained.

In the second example embodiment, in the pull-out operation of the transporters, the pipe transporters 12A and 12B are retracted relative to the pipe 50. Alternatively, in the pull-out operation of the transporters, the pipe transporters 12A and 12B may not be retracted relative to the pipe 50.

In the second example embodiment, after the pull-in work of the pipe 50 is completed and before the pipe lifting jig 70A is set in the second straight pipe portion K3, the pipe lateral casters 23 are detached from the caster band 21. Alternatively, as long as a sufficient clearance is maintained between the inner wall of the existing pipeline and the upper end of the pipe, both the pair of casters 212 and the pipe lateral casters may be detached from the annular body 211 of the caster band 21 in the state where the pipe is lifted by the pipe lifting jigs.

Example embodiments of the present invention are applicable to pipe transport devices to transport pipes to be installed in existing pipelines, and piping methods to install the pipes in the existing pipelines.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A pipe transport device to transport a pipe to be installed in an existing pipeline, the pipe transport device comprising:
a pipe support that is a rod-shaped structure and penetrates the pipe to support the pipe, the pipe having flexibility; and
a pipe transporter detachably supporting the pipe support and configured to transfer the supported pipe support, wherein
the pipe transporter is configured to transfer the pipe supported by the pipe support along an axial direction of the pipeline in the existing pipeline, in a state where the pipe transporter supports the pipe support.

2. The pipe transport device according to claim 1, wherein
the pipe support includes:
a rod-shaped portion extending in one direction; and
a projection portion that projects in a direction intersecting with the one direction with respect to the rod-shaped portion, and supports a coupling of the pipe, the pipe including a plurality of displacement portions and the coupling is configured to couple the displacement portions to each other.

3. The pipe transport device according to claim 2, wherein a position of the projection portion in the one direction is adjustable relative to the rod-shaped portion.

4. A piping method for installing a pipe in an existing pipeline, the method comprising:
a pipe support insertion step of inserting a pipe support into the pipe having flexibility;
a pipe support supporting step of supporting the pipe support with a pipe transporter; and
a pipe transfer step of transferring by the pipe transporter, in the existing pipeline, the pipe supported by the pipe support along an axial direction of the pipeline.

5. The piping method according to claim 4, further comprising:
after the pipe transfer step, in a state where the pipe support is detached from the pipe transporter:
a pipe support pull-out step of pulling out the pipe support from the pipe; wherein
a pipeline includes a first straight pipe portion including an opening at one end, a bent pipe portion including one end connected to another end of the first straight pipe portion, and a second straight pipe portion including one end connected to another end of the bent pipe portion; and
the piping method further includes a moving step of pulling the pipe from the second straight pipe portion of the pipeline to move the pipe to the another end of the bent pipe portion while bending the pipe along a curve of the bent pipe portion.

6. The piping method according to claim 5, wherein
the moving step includes:
a support ring setting step of setting a support ring in the second straight pipe portion;
a winding device disposing step of disposing a winding device in the support ring;
a coupling step of coupling the pipe and the winding device to each other by a wire; and
a pulling step of pulling the pipe toward the support ring by winding the wire by the winding device.

7. The piping method according to claim 5, wherein in the pipe support pull-out step, a pipe lifting jig is set in the first straight pipe portion and lifts the pipe support relative to the pipe transporter so that the pipe support is separated from the pipe transporter and the pipe support is pulled out from the pipe.

8. The piping method according to claim 7, wherein in the pipe support pull-out step, in the state where the pipe support is separated from the pipe transporter, the pipe transporter is retracted relative to the pipe.

9. The piping method according to claim 8, further comprising a caster attachment step of attaching, to an outer surface of the pipe, a caster configured to move the pipe in the existing pipeline, before the moving step.
